(19) United States
(12) Patent Application Publication
(10) Pub. No.: US 2006/0156039 A1
(43) Pub. Date: Jul. 13, 2006

(54) Power supply for an asynchronous data treatment circuit

(75) Inventors: Vincent Deveaud, Fuveau (FR); Pierre-Yvan Liardet, Peynier (FR)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: STMicroelectronics S.A., Montrouge (FR)

(21) Appl. No.: 10/528,523

(22) PCT Filed: Sep. 19, 2003
(86) PCT No.: PCT/FR03/50055

§ 371 Date: Aug. 30, 2005

(30) Foreign Application Priority Data
Sep. 19, 2002 (FR) 02/11657

(51) Int. Cl. G06F 1/26

(52) U.S. Cl. 713/300

(57) ABSTRACT

The invention relates to a method and feed circuit for an asynchronous calculation element (1) of an integrated circuit, wherein the instantaneous power supply of the calculation element is randomly varied.

The present invention relates to integrated circuits or integrated circuit elements asynchronously executing digital data processings. The present invention more specifically relates to circuits handling data which are desired to be protected, for example, confidential data or authentication keys.

A common type of attacks of an integrated circuit executing secured algorithm consists of analyzing the power consumption of the integrated circuit or of the portion thereof executing the algorithm handling secret data. Such power consumption analysis attacks are known as the SPA (single power analysis) or DPA (differential power analysis) and consist of analyzing the power consumption of an integrated circuit according to the data that it processes to discover data meant to be secret.

In a circuit operating asynchronously, the circuit provides the output data at the same time as information that these data are available, once the processing has been completed. A power analysis attack of an asynchronous circuit consists of observing the power peaks which actually correspond to data (at the times when these data are processed). It is then possible, for a pirate, to discover the algorithm or the handled secret data.

To attempt masking the data processings, a known solution consists of adding additional processing circuits, useless for the actual secure process, but which consume power when they handle data. The data handled by the asynchronous process to be protected are then in a way masked by the power drawn by the additional processing circuits.

Apart from the fact that the efficiency of such a solution is in a way proportional to the number of provided additional processing circuits, and thus to the additional bulk in the integrated circuit, it only increases the number of possible data combinations that the pirate must evaluate.

Actually, if the additional power consumption depends on the processed data, these data remain vulnerable. If the additional power consumption is independent from the processed data, it represents in a way a noise that can be suppressed by statistical methods.

Further, adding processings increases the power consumption.

The present invention aims at providing another solution to protect the execution of an asynchronous algorithmic process against power analysis attacks of the integrated circuit or of the integrated circuit portion executing this process.

The present invention especially aims at providing a solution, the efficiency of which is not linked to the additional bulk in the integrated circuit.

The present invention also aims at providing a solution which does not simply translate as in increase in the possible combinations to be examined by the pirate.

To achieve these and other objects, the present invention provides a method for supplying an asynchronous calculation element of an integrated circuit, consisting of randomly varying the instantaneous supply power of the calculation element.

According to an embodiment of the present invention, the instantaneous power provided to the calculation element is randomly distributed in a predetermined time window, the total power in the window being predetermined.

According to an embodiment of the present invention, the total power provided to the calculation element in the time window is determined according to the maximum possible power consumption of the calculation element.

The present invention also provides a circuit for supplying at least one asynchronous processing element of an integrated circuit, comprising a variable supply element randomly or pseudo-randomly controlled.

According to an embodiment of the present invention, said variable supply element varies the supply voltage of the asynchronous processing element.

According to an embodiment of the present invention, the variable supply element is controlled by a pseudo-random generator.

The foregoing objects, features and advantages of the present invention, will be discussed in detail in the following non-limiting description of specific embodiments in connection with the accompanying drawings, in which:

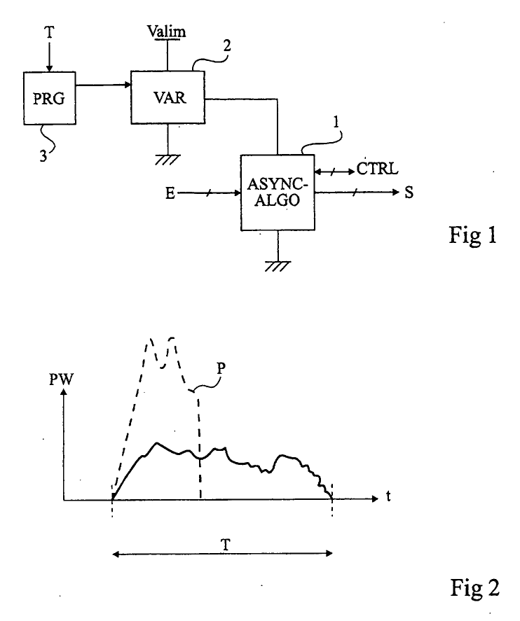

FIG. 1 very schematically shows in the form of blocks an embodiment of a supply circuit of an asynchronous calculation element according to the present invention; and

FIG. 2 illustrates in a flowchart an embodiment of the supply method according to the present invention.

For clarity, only those method steps and circuit elements which are necessary to the understanding of the present invention have been shown in the drawings and will be described hereafter. In particular, the algorithm implemented by the calculation element to be protected has not been detailed and is no object of the present invention, the present invention applying whatever the implemented asynchronous process. Further, the asynchronous calculation element is of course most often associated with other circuit elements with which it is integrated. Reference will only be made hereafter to the asynchronous calculation element and to its power supply, the present invention having no effect upon the rest of the circuit which depends on the application.

A feature of the present invention is to randomly vary the power supplied to the element of asynchronous processing of the data to be protected.

The present invention takes advantage of the fact that, in an asynchronous processing element, a lack of power with respect to the power required for the handling of a datum does not translate as an operating error but merely as a delay in the data processing. Indeed, an asynchronous processing element waits in a way to have the power necessary for the processing to carry on its calculation.

In conventional circuits, the power source is sufficient to provide the processing element with all the power that it requires at any time. According to the present invention, the power provided to the processing element is imposed.

For example, a pseudo-random generator taking into account the duration desired for the calculation is used to distribute the amount of power necessary for this calculation in a time window.

Indeed, the only counterpart of the implementation of the present invention is a lengthening of the execution time. This execution time may however be maintained within a predetermined window due to a pseudo-random generation.

Should the application allow for it, especially should it impose no time constraints, then can a random generator be used, which has the advantage of dissociating no only the supply, but also the duration with respect to the processed data. The processing time is thus made random.

FIG. 1 partially and very schematically shows in the form of blocks an embodiment of a circuit for supplying an element 1 of asynchronous execution of a data processing algorithm (ASYNC-ALGO). Conventionally, the asynchronous calculation element may be schematized as a circuit receiving input data E, providing output data S, and exchanging control signals (CTRL) with the rest of the integrated circuit (for example, with a microprocessor not shown). Among the control signals is especially the signal by which element 1 indicates to the rest of the integrated circuit that output data S are available.

According to the present invention, circuit 1 is supplied by means of a circuit 2 (VAR). Circuit 2 provides a variable power to circuit 1 and is supplied by a voltage Valim, for example, the integrated circuit supply voltage. In the sense of the present invention, the power variation may be performed in voltage or current, while respecting if need be the minimum supply constraints (for example, in voltage level) to avoid loosing the data under processing by asynchronous circuit 1.

According to the embodiment shown in FIG. 1, power supply variation circuit 2 is controlled by a pseudo-random generator 3 (PRG) to randomly distribute the power while respecting a predetermined time window T corresponding to the desired duration for the calculation execution. Generator 3 receives reference value T, for example, from the CPU of the integrated circuit setting the time window.

In the case where a same integrated circuit contains several distinct asynchronous processing circuits, said circuits may be supplied separately from one another or together by means of a same variable generator 2.

FIG. 2 illustrates the operation of the circuit of FIG. 1 by a flowchart representing the power (PW) provided to circuit 1 in a time window T of execution of the calculation.

FIG. 2 shows, by a dotted line p, what the power absorbed by circuit 1 could be in a conventional case, if said circuit was directly supplied by voltage Valim without using variable generator 2 specific to the present invention. In this case, element 1 takes as much power as it instantaneously needs. This is what enables a possible pirate to analyze power consumption peaks and link them to the processed data (bits 0 or 1).

According to the present invention, the same amount of power required for the execution of the entire calculation is randomly distributed in time in window T. As indicated hereabove, the only consequence is a lengthening of the calculation time with respect to the conventional case. However, this lengthening may be, if need be, limited to a predetermined time window of the pseudo-random generator.

An advantage of the present invention is that it enables masking the data handled by an asynchronous element in a particularly efficient fashion and, especially, without for it to translate as an increase in the combinations to be examined by the possible pirate. Indeed, no additional processing (calculation) of the data is provided by the present invention. Accordingly, the system efficiency is not linked to the increase in the processing circuit bulk.

Another advantage of the present invention is that it requires no modification of the actual asynchronous processing element. Only its supply is modified. This advantage especially results in that the present invention can be implemented in any existing asynchronous processing process without generating modifications of the calculation portion of the existing integrated circuit.

Another advantage of the present invention is that it generates no additional power consumption for the execution of the actual calculation, conversely to solutions requiring additional processing circuits.

The practical implementation of the present invention based on the functional indications given hereabove is within the abilities of those skilled in the art. In particular, the forming of a variable generator supplying an asynchronous calculation element only requires conventional components and is within the abilities of those skilled in the art.

Of course, the present invention is likely to have various alterations, modifications, and improvement which will readily occur to those skilled in the art. In particular, the determination of the possible minimum power level required to be provided to an asynchronous processing element to preserve the data that it is processing depends on the application and those skilled in the art will be capable of setting the adapted thresholds. For example, a minimum supply voltage threshold may be set and the processing circuit supply voltage may be randomly varied within a predetermined range. Finally, the forming of a generator of a random or pseudo-random reference value generator requires conventional means which are within the abilities of those skilled in the art.

1. A method for supplying an asynchronous calculation element of an integrated circuit, comprising randomly distributing, in a predetermined time window, the an instantaneous supply power of the calculation element, the total power in the window being predetermined.

2. The method of claim 1, wherein the total power provided to the calculation element in the time window is determined according to a maximum possible power consumption of the calculation element.

3. A circuit for supplying at least one asynchronous processing element of an integrated circuit, comprising a variable supply element of the asynchronous processing element,
randomly distributed, and in a predetermined time window, the instantaneous energy provided to the calculation element, the total power in the window being predetermined.

4. The circuit of claim 3, wherein the variable supply element is controlled by a pseudo-random generator.
